(19) United States
(12) Patent Application Publication
(10) Pub. No.: US 2022/0317084 A1
(43) Pub. Date: Oct. 6, 2022

(54) CERAMIC HEATER, METHOD OF DRIVING CERAMIC HEATER, AND GAS SENSOR

(71) Applicant: NGK INSULATORS, LTD., Nagoya (JP)

(72) Inventors: Kana IBATA, Nagoya (JP); Yusuke WATANABE, Nagoya (JP); Shiho IWAI, Nagoya (JP); Takayuki SEKIYA, Nagoya (JP); Yosuke NORITAKE, Vernon Hills, IL (US); Daichi KONDO, Kaizu (JP)

(21) Appl. No.: 17/694,996

(22) Filed: Mar. 15, 2022

(30) Foreign Application Priority Data
Mar. 31, 2021 (JP) 2021-059115
Mar. 2, 2022 (JP) 2022-031411

(51) Int. Cl. G01N 27/407; G01N 27/406; G01N 27/419; H05B 3/14; H05B 1/02

(52) U.S. Cl. CPC G01N 27/4073; G01N 27/4067; G01N 27/419; H05B 3/141; H05B 1/0247

(57) ABSTRACT

A ceramic heater is provided in an electronic component, and by supplying electrical current thereto, a heat generating portion thereof is heated to a temperature of greater than or equal to 700[° C.] and less than 950[° C.]. An energizing current waveform of the electrical current to the heat generating portion is a pulse waveform, and a product of a pulse voltage Vp [V] and a period T [ms] of the pulse waveform is less than or equal to 600 [V·ms].

### CROSS-REFERENCE TO RELATED APPLICATIONS

This application is based upon and claims the benefit of priority from Japanese Patent Application No. 2021-059115 filed on Mar. 31, 2021 and Japanese Patent Application No. 2022-031411 filed on Mar. 2, 2022, the contents of which are incorporated herein by reference.

### BACKGROUND OF THE INVENTION

### Field of the Invention

The present invention relates to a ceramic heater, a method of driving a ceramic heater, and a gas sensor.

### Description of the Related Art

JP 4035555 B2 addresses a problem of providing a gas sensor element, which is superior at high temperatures and in heating and cooling cycles, is superior in terms of high speed starting ability, is capable of performing accurate measurements, and furthermore, is low in power consumption.

In order to solve this problem, the gas sensor element includes an insulating base, an Ip cell (pumping cell), and a Vs cell (detection cell). The insulating base is a member containing alumina as a principal component thereof. Each of the Ip cell and the Vs cell includes a solid electrolyte layer and a pair of electrodes. A diffusion chamber is formed between the Ip cell and the Vs cell. In the interior of the gas sensor element, inner walls that define the diffusion chamber are provided in a direction perpendicular to the stacking direction. One electrode of the Ip cell and one electrode of the Vs cell face toward each other. One electrode of the Ip cell and one electrode of the Vs cell form at least one part of an inner wall. The insulating base is arranged in the Ip cell and the Vs cell at a location where the diffusion chamber is not formed. The insulating base is directly joined to the Ip cell and the Vs cell.

Alternatively, the insulating base is indirectly joined to the Ip cell and the Vs cell via another member. The solid electrolyte layer contains greater than or equal to 95 [mass %] of stabilized zirconia and alumina in total. The solid electrolyte layer contains from 20 [mass %] to 90 [mass %] of stabilized zirconia. The solid electrolyte layer contains from 80 [mass %] to 10 [mass %] of alumina.

JP 2001-135465 A addresses a problem of accounting for deterioration in the durability of a ceramic heater due to ion migration of an alkali metal or an alkaline earth metal when the ceramic heater is used at high temperatures.

More specifically, in order to resolve this problem, the ceramic that is used as the base material of the ceramic heater contain Al₂O₃, SiO₂, and a rare earth element oxide. The ceramic contain 90 [% by weight] to 99 [% by weight] of Al₂O₃. Further, the ceramic contains from 0.5 [% by weight] to 4 [% by weight] of SiO₂. Furthermore, the ceramic contain from 0.5 [% by weight] to 6 [% by weight] of a rare earth element oxide. The ceramic further contain MgO and CaO. The total amount of MgO and CaO is less than or equal to 0.4 parts by weight with respect to 100 parts by weight of the total amount of Al₂O₃, SiO₂, and the rare earth element oxide.

JP 2012-146449 A has the object of providing a gas sensor element having a ceramic heater in which migration is suppressed and which improves the adhesion strength of terminal electrodes, the ceramic heater being used as a heat source, and a sensor unit that detects electrical characteristics that change depending on the concentration of a specified component in a gas to be measured.

In order to solve this problem, the ceramic heater of the gas sensor element includes a heating element, a pair of heating element lead portions, and a pair of terminal electrodes. The heating element generates heat by supplying current thereto on an inner side of an insulator containing heat-resistant ceramic as a principal component thereof. Within the insulator of the ceramic heater, at least a portion thereof that the heating element is in direct contact with is an insulator layer having a relatively high content of the heat-resistant ceramic. Furthermore, within the insulator of the ceramic heater, a portion thereof that is in direct contact with the terminal electrodes is an insulator layer in which the content of the principal component of the heat-resistant ceramic is relatively low.

### SUMMARY OF THE INVENTION

An NOx sensor element is equipped with a ceramic heater. The heat generating portion of the ceramic heater is heated by supplying electrical current thereto. In such a ceramic heater, a problem arises in that thinning or a disconnection of the heat generating portion is caused due to being continuously (consecutively) driven or intermittently driven over a prolonged time period.

Migration (ion migration) can be cited as a cause of deterioration of such a ceramic heater. Migration is a phenomenon in which impurities contained in a heater electrode or a heater insulating layer undergo movement due to an applied voltage, or a phenomenon in which cations of an alkali metal or alkaline earth metal contained within a sintering aid undergo movement due to an applied voltage.

Such migration is accelerated due to a voltage difference or the temperature, and progresses as the time period that the heater is driven elapses.

The present invention has the object of solving the aforementioned problems.

A ceramic heater according to one aspect of the present invention is a ceramic heater provided in an electronic component, the ceramic heater being configured so that by supplying electrical current thereto, a heat generating portion thereof is heated to a temperature of greater than or equal to 700[° C.] and less than 950[° C.], and wherein an energizing current waveform of the electrical current to the heat generating portion is a pulse waveform, and a product of a pulse voltage [V] and a period [ms] of the pulse waveform is less than or equal to 600 [V·ms].

A method of driving a ceramic heater according to one aspect is a method of driving a ceramic heater provided in an electronic component, the ceramic heater being configured so that by supplying electrical current thereto, a heat generating portion thereof is heated to a temperature of greater than or equal to 700[° C.] and less than 950[° C.], wherein an energizing current waveform of the electrical current to the heat generating portion is a pulse waveform, and a product of a pulse voltage Vp [V] and a period [ms] of the pulse waveform is less than or equal to 600 [V·ms].

A gas sensor according to one aspect of the present invention has a ceramic heater, the ceramic heater being configured so that by supplying electrical current thereto, a heat generating portion thereof is heated to a temperature of greater than or equal to 700[° C.] and less than 950[° C.], wherein an energizing current waveform of the electrical current to the heat generating portion is a pulse waveform, and a product of a pulse voltage Vp [V] and a period [ms] of the pulse waveform is less than or equal to 600 [V·ms].

According to the present invention, by being applied to an electronic component such as a gas sensor or the like, deterioration due to driving of the heater can be suppressed.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a cross-sectional view in which there is shown a gas sensor according to an embodiment of the present invention;

FIG. 2 is a schematic cross-sectional view schematically showing an exemplary configuration of the sensor element;

FIG. 3 is a diagram showing one example of a relationship between a pulse voltage Vp, a period T, and a pulse width W;

FIG. 4 is an explanatory diagram showing an electrically connected relationship of a heater portion of the gas sensor;

FIG. 5 is an explanatory diagram showing a state in which an electric field is generated between a first pattern (conductor) and a second pattern (conductor);

FIG. 6A is a diagram showing a first example of an energizing current waveform to the heat generating portion;

FIG. 6B is a diagram showing a second example of an energizing current waveform to the heat generating portion;

FIG. 7A is a diagram showing a third example of an energizing current waveform to the heat generating portion;

FIG. 7B is a diagram showing a fourth example of an energizing current waveform to the heat generating portion;

FIG. 8 is a diagram showing a fifth example of an energizing current waveform to the heat generating portion;

FIG. 9 is a diagram showing a sixth example of an energizing current waveform to the heat generating portion;

FIG. 10 is a Table 1 showing test levels and test results of a pulse voltage Vp [V], a period T [ms], and a drive voltage parameter X [V·ms] of Examples 1 to 9 and Comparative Example;

FIG. 11 is a Table 2 showing determination criteria of a rate of increase in a heater resistance value;

FIG. 12 is a graph showing a relationship between the rate of increase in the heater resistance value with respect to the drive voltage parameter X [V·ms] of Examples 1 to 9 and Comparative Example;

FIG. 13 is an explanatory diagram showing an electrically connected relationship of a heater portion according to a first modified example;

FIG. 14 is an explanatory diagram showing an electrically connected relationship of a heater portion according to a second modified example; and

FIG. 15 is an explanatory diagram showing an electrically connected relationship of a heater portion according to a third modified example.

### DESCRIPTION OF THE INVENTION

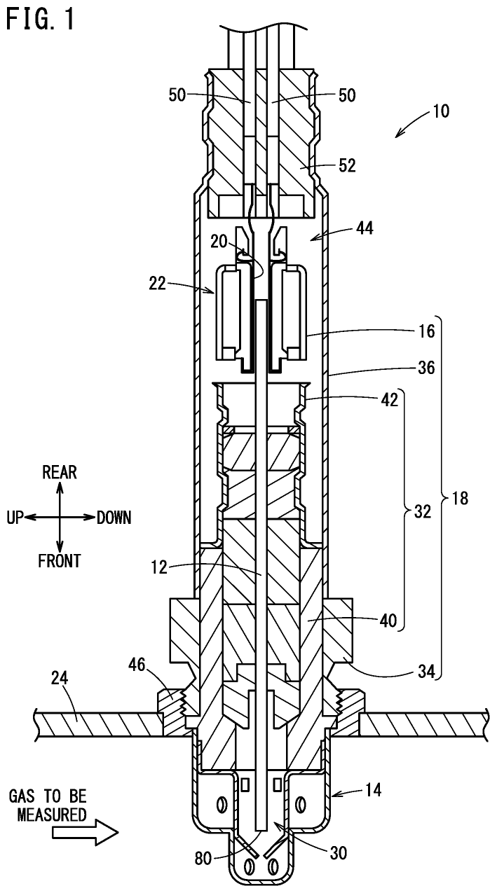

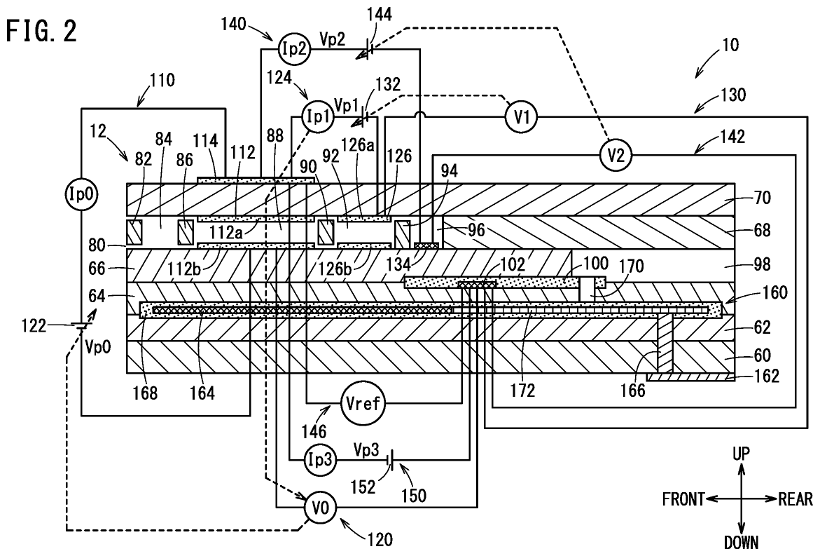

As shown in FIG. 1, a gas sensor 10 according to the present embodiment is equipped with a sensor element 12. The sensor element 12 has an elongate rectangular parallelepiped shape. In the following description, a longitudinal direction of the sensor element 12 (the upper-lower direction shown in FIG. 1 and the left-right direction shown in FIG. 2) is defined as a front-rear direction of the gas sensor 10 and the sensor element 12. Further, a thickness direction of the sensor element 12 (the left-right direction shown in FIG. 1 and the upper-lower direction shown in FIG. 2) is defined as a vertical direction of the gas sensor 10 and the sensor element 12. Furthermore, a widthwise direction of the sensor element 12 (a direction perpendicular to the front-rear direction and the upper-lower direction of the gas sensor 10 and the sensor element 12) is defined as a left-right direction of the gas sensor 10 and the sensor element 12.

As shown in FIG. 1, the gas sensor 10 is equipped with the sensor element 12, a protective cover 14, and a sensor assembly 18. The protective cover 14 protects a front end part of the sensor element 12. The sensor assembly 18 includes a ceramic housing 16. A metal terminal 20 is mounted on the ceramic housing 16. The metal terminal 20 retains a rear end part of the sensor element 12. The metal terminal 20 is electrically connected to the sensor element 12. In accordance therewith, the ceramic housing 16 functions as a connector 22.

The gas sensor 10 is attached, for example, to a pipe 24 such as a vehicle exhaust gas pipe. The gas sensor 10 measures the concentration of a specified gas, which serves as a gas to be measured, contained within the exhaust gas. The specified gas may be NOx or O₂ or the like.

A plurality of holes are formed in the protective cover 14. The plurality of holes allow the gas to be measured to flow inside the protective cover 14. A space surrounded by the protective cover 14 serves as a sensor element chamber 30. A front end of the sensor element 12 is arranged inside the sensor element chamber 30.

The sensor assembly 18 includes an element sealing body 32 and a nut 34. The element sealing body 32 encloses and fixes the sensor element 12 inside the gas sensor 10. The nut 34 is attached to the element sealing body 32. The sensor assembly 18 includes an outer cylinder 36 and the aforementioned connector 22. Non-illustrated electrodes are formed on surfaces (upper and lower surfaces) of the rear end part of the sensor element 12. By being in contact with each of the non-illustrated electrodes, the connector 22 is electrically connected to each of the electrodes.

The element sealing body 32 includes a cylindrical main metal fitting 40 and a tubular inner cylinder 42. The inner cylinder 42 is fixed by welding coaxially with the main metal fitting 40. The element sealing body 32 includes a ceramic supporter, a green compact, a metal ring, and the like. The ceramic supporter, the green compact, the metal ring, and the like are sealed inside of through holes on the inner side of the main metal fitting 40 and the inner cylinder 42. Consequently, a location between the sensor element chamber 30 inside the protective cover 14 and the space 44 inside the outer cylinder 36 is sealed. Further, the sensor element 12 is fixed to the element sealing body 32.

The nut 34 is fixed coaxially with the main metal fitting 40. A male threaded portion is formed on the outer circumferential surface of the nut 34. The male threaded portion of the nut 34 is inserted into a fixing member 46. The fixing member 46 is welded to the pipe 24. A female threaded portion is provided on an inner circumferential surface of the fixing member 46. The male threaded portion of the nut 34 is screwed-engaged with the female threaded portion. Consequently, the gas sensor 10 is fixed to the pipe 24. Within the gas sensor 10, the front end of the sensor element 12 and a portion of the protective cover 14 project out into the interior of the pipe 24.

The outer cylinder 36 covers at least the periphery of the inner cylinder 42, the sensor element 12, and the connector 22. A plurality of lead wires 50 are connected to the connector 22. The plurality of lead wires 50 extend outward from a rear end of the outer cylinder 36. The plurality of lead wires 50 carry out conduction with each of the electrodes (to be described later) of the sensor element 12 via the connector 22. A gap between the outer cylinder 36 and the lead wires 50 is sealed by an elastic insulating member 52. The elastic insulating member 52 is constituted, for example, by a grommet. The space 44 inside the outer cylinder 36 is filled with a reference gas (atmospheric gas in the present embodiment). A rear end of the sensor element 12 is arranged inside the space 44.

As shown in FIG. 2, the sensor element 12 includes, for example, a stacked body in which six layers are stacked sequentially from a lower side as viewed in the drawing. The six layers are a first substrate layer 60, a second substrate layer 62, a third substrate layer 64, a first solid electrolyte layer 66, a spacer layer 68, and a second solid electrolyte layer 70. The six layers described above are composed respectively of an oxygen ion conductive solid electrolyte layer such as zirconia (ZrO₂) or the like. Further, the solid electrolyte that forms these six layers is dense and airtight. The sensor element 12 is manufactured in the following manner. For example, with respect to ceramic green sheets corresponding to each of the respective layers, predetermined machining processes and printing of circuit patterns and the like are carried out. Next, the respective ceramic green sheets are stacked to thereby form the stacked body. Thereafter, the stacked body is subjected to firing and is integrated.

The sensor element 12 includes a plurality of diffusion rate control members and a plurality of internal vacancies. The plurality of diffusion rate control members and the plurality of internal vacancies are disposed between a lower surface of the second solid electrolyte layer 70 and an upper surface of the first solid electrolyte layer 66. More specifically, the sensor element 12 includes a gas introduction port 80, a first diffusion rate control member 82, a buffer space 84, a second diffusion rate control member 86, a first internal vacancy 88, a third diffusion rate control member 90, a second internal vacancy 92, a fourth diffusion rate control member 94, and a third internal vacancy 96.

The gas introduction port 80, the buffer space 84, the first internal vacancy 88, the second internal vacancy 92, and the third internal vacancy 96 are provided by hollowing out the spacer layer 68. The buffer space 84 and the like are spaces in the interior of the sensor element 12. More specifically, the upper parts of such spaces are defined by the lower surface of the second solid electrolyte layer 70. Further, the lower parts of such spaces are defined by the upper surface of the first solid electrolyte layer 66. Furthermore, the side parts of such spaces are defined by side surfaces of the spacer layer 68.

Each of the first diffusion rate control member 82, the second diffusion rate control member 86, and the third diffusion rate control member 90 is configured in the form of two horizontally elongated slits. Further, the fourth diffusion rate control member 94 is defined by one horizontally elongated slit which is formed as a gap from the lower surface of the second solid electrolyte layer 70. A longitudinal direction of such slits is perpendicular to the page of FIG. 2. Further, the portion from the gas introduction port 80 to the third internal vacancy 96 is also referred to as a gas-to-be-measured flow through section.

A reference gas introduction space 98 is provided at a position more distant from one end side (distal end side) of the sensor element 12 than the gas-to-be-measured flow through section. More specifically, the reference gas introduction space 98 lies between the upper surface of the third substrate layer 64 and the lower surface of the spacer layer 68, and is provided at a position where side parts thereof are defined by side surfaces of the first solid electrolyte layer 66. For example, atmospheric gas (the atmosphere inside the space 44 shown in FIG. 1) is introduced into the reference gas introduction space 98 as a reference gas when measurement of the NOx concentration is performed.

An atmospheric gas introduction layer 100 includes ceramic such as porous alumina. The atmospheric gas introduction layer 100 is exposed to the reference gas introduction space 98. The reference gas is introduced into the atmospheric gas introduction layer 100 through the reference gas introduction space 98. Further, the atmospheric gas introduction layer 100 covers a reference electrode 102. While imparting a predetermined diffusion resistance with respect to the reference gas inside the reference gas introduction space 98, the atmospheric gas introduction layer 100 introduces the reference gas to which the diffusion resistance is imparted to the reference electrode 102.

Further, within the atmospheric gas introduction layer 100, a more rear end side (the right side shown in FIG. 2) of the sensor element 12 than the reference electrode 102 is exposed to the reference gas introduction space 98. Stated otherwise, the reference gas introduction space 98 is not formed up to a location directly above the reference electrode 102. However, the reference electrode 102 may be formed directly below the reference gas introduction space 98 shown in FIG. 2.

The reference electrode 102 is an electrode that is sandwiched between the upper surface of the third substrate layer 64 and the first solid electrolyte layer 66. The atmospheric gas introduction layer 100, which is connected to the reference gas introduction space 98, is disposed around the periphery of the reference electrode 102. The reference electrode 102 is formed directly on the upper surface of the third substrate layer 64. In the reference electrode 102, a portion other than a portion in contact with the upper surface of the third substrate layer 64 is covered by the atmospheric gas introduction layer 100. Further, as will be discussed later, using the reference electrode 102, it is possible to measure the oxygen concentration (oxygen partial pressure) inside the first internal vacancy 88, inside the second internal vacancy 92, and inside the third internal vacancy 96. The reference electrode 102 is a porous cermet electrode (for example, a cermet electrode of Pt and ZrO₂).

The gas introduction port 80 is opened with respect to the external space. The gas introduction port 80 draws in the gas to be measured into the interior of the sensor element 12 from the external space. The first diffusion rate control member 82 imparts a predetermined diffusion resistance with respect to the gas to be measured which is drawn in from the gas introduction port 80. The buffer space 84 guides the gas to be measured, which is introduced from the gas introduction port 80 and through the first diffusion rate control member 82, to the second diffusion rate control member 86. The second diffusion rate control member 86 imparts a predetermined diffusion resistance with respect to the gas to be measured which is drawn into the first internal vacancy 88 from the buffer space 84.

In this instance, a description will be given of an example of actions that occur due to pressure fluctuations of the gas to be measured in the external space, at a time when the gas to be measured is introduced from the exterior of the sensor element 12 into the interior of the first internal vacancy 88. As the above-described pressure fluctuations, there may be cited pulsations of the exhaust pressure, in the case that the gas to be measured is an exhaust gas of an automobile. Due to the above-described pressure fluctuations, the gas to be measured is rapidly drawn into the sensor element 12 from the gas introduction port 80. However, fluctuations in the concentration of the gas to be measured are negated through the first diffusion rate control member 82, the buffer space 84, and the second diffusion rate control member 86. After the fluctuations in the concentration have been negated, the gas to be measured is introduced into the first internal vacancy 88. Consequently, the fluctuations in the concentration of the gas to be measured that is introduced into the first internal vacancy 88 can be regarded as negligible. The first internal vacancy 88 is a space in order to adjust the oxygen partial pressure within the gas to be measured that is introduced through the second diffusion rate control member 86. The aforementioned oxygen partial pressure is adjusted by operation of a later-described main pumping cell 110.

The main pumping cell 110 is an electrochemical pumping cell. The main pumping cell 110 includes an inner side pump electrode 112, an outer side pump electrode 114, and the second solid electrolyte layer 70. The inner side pump electrode 112 is disposed on an inner surface of the first internal vacancy 88. The outer side pump electrode 114 is provided, within the upper surface of the second solid electrolyte layer 70, in a region corresponding to the inner side pump electrode 112. The outer side pump electrode 114 is exposed to an external space (the sensor element chamber 30 shown in FIG. 1) in a region corresponding to the inner side pump electrode 112. The second solid electrolyte layer 70 is sandwiched between the inner side pump electrode 112 and the outer side pump electrode 114.

The inner side pump electrode 112 is formed to span over the upper and lower solid electrolyte layers (the second solid electrolyte layer 70 and the first solid electrolyte layer 66) that define the first internal vacancy 88, and the spacer layer 68 that makes up the side walls. More specifically, a ceiling electrode portion 112a of the inner side pump electrode 112 is formed on the lower surface of the second solid electrolyte layer 70. The lower surface of the second solid electrolyte layer 70 constitutes a ceiling surface of the first internal vacancy 88. A bottom electrode portion 112b is directly formed on the upper surface of the first solid electrolyte layer 66. The upper surface of the first solid electrolyte layer 66 constitutes a bottom surface of the first internal vacancy 88. The ceiling electrode portion 112a and the bottom electrode portion 112b are connected via side electrode portions (illustration of which is omitted). The side electrode portions are formed on side wall surfaces (inner surfaces) of the spacer layer 68 that constitute both side wall portions of the first internal vacancy 88. More specifically, the inner side pump electrode 112 is arranged as a tunnel-like arrangement structure.

The inner side pump electrode 112 and the outer side pump electrode 114 are formed as porous cermet electrodes. The porous cermet electrodes, for example, are cermet electrodes made of ZrO₂ and Pt containing 1 [%] of Au. Moreover, the inner side pump electrode 112, which is in contact with the gas to be measured, is formed using a material having a weakened reduction capability with respect to the NOx component within the gas to be measured.

The main pumping cell 110 applies a desired pump voltage Vp0 between the inner side pump electrode 112 and the outer side pump electrode 114. Consequently, a pump current Ip0 flows in a positive direction or a negative direction between the inner side pump electrode 112 and the outer side pump electrode 114. As a result, the main pumping cell 110 is capable of pumping out the oxygen inside the first internal vacancy 88 to the external space. Further, the main pumping cell 110 is capable of drawing oxygen in the external space into the first internal vacancy 88.

Further, the sensor element 12 includes an oxygen partial pressure detecting sensor cell 120 for controlling the main pump. Hereinafter, the oxygen partial pressure detecting sensor cell 120 for controlling the main pump will be referred to as a main pump sensor cell 120. The main pump sensor cell 120 detects the oxygen concentration (oxygen partial pressure) inside the first internal vacancy 88. The main pump sensor cell 120 is an electrochemical sensor cell. The main pump sensor cell 120 includes the inner side pump electrode 112, the second solid electrolyte layer 70, the spacer layer 68, the first solid electrolyte layer 66, and the reference electrode 102.

By measuring the electromagnetic force V0 of the main pump sensor cell 120, the sensor element 12 detects the oxygen concentration (oxygen partial pressure) inside the first internal vacancy 88. Furthermore, the sensor element 12 controls the pump current Ip0 by feedback-controlling the pump voltage Vp0 of the variable power source 122 in a manner so that the electromotive force V0 becomes constant. Consequently, the oxygen concentration inside the first internal vacancy 88 is maintained at a predetermined constant value.

The third diffusion rate control member 90 imparts a predetermined diffusion resistance to the gas to be measured, the oxygen concentration (oxygen partial pressure) of which is controlled by operation of the main pumping cell 110 in the interior of the first internal vacancy 88. The third diffusion rate control member 90 guides the gas to be measured to which the predetermined diffusion resistance is imparted into the second internal vacancy 92.

The second internal vacancy 92 is a space in order to carry out adjustment of the oxygen partial pressure by the auxiliary pumping cell 124, with respect to the gas to be measured that is introduced through the third diffusion rate control member 90. Consequently, the oxygen concentration inside the second internal vacancy 92 is maintained at a constant value with high accuracy. As a result, the gas sensor 10 is capable of measuring the NOx concentration with high accuracy.

The auxiliary pumping cell 124 is an electrochemical pumping cell. The auxiliary pumping cell 124 includes an auxiliary pump electrode 126, the outer side pump electrode 114, and the second solid electrolyte layer 70. The auxiliary pump electrode 126 is disposed on an inner surface of the second internal vacancy 92. Moreover, the outer side pump electrode 114 may be an appropriate electrode provided on an outer side of the sensor element 12.

The auxiliary pump electrode 126 is arranged inside the second internal vacancy 92. The auxiliary pump electrode 126 includes a tunnel-like arrangement structure, in the same manner as the inner side pump electrode 112 provided inside the first internal vacancy 88. Stated otherwise, the auxiliary pump electrode 126 includes a ceiling electrode portion 126a formed on the second solid electrolyte layer 70. The second solid electrolyte layer 70 constitutes a ceiling surface of the second internal vacancy 92. In addition, the auxiliary pump electrode 126 further includes a bottom electrode portion 126b formed directly on the upper surface of the first solid electrolyte layer 66. The upper surface of the first solid electrolyte layer 66 constitutes a bottom surface of the second internal vacancy 92. The ceiling electrode portion 126a and the bottom electrode portion 126b are connected via side electrode portions (illustration of which is omitted). The side electrode portions are formed respectively on both wall surfaces of the spacer layer 68 that constitute the side walls of the second internal vacancy 92. Moreover, in the same manner as the inner side pump electrode 112, the auxiliary pump electrode 126 is also formed using a material having a weakened reduction capability with respect to the NOx component within the gas to be measured.

The auxiliary pumping cell 124 applies a desired pump voltage Vp1 between the auxiliary pump electrode 126 and the outer side pump electrode 114. Consequently, the auxiliary pumping cell 124 is capable of pumping out the oxygen within the atmosphere inside the second internal vacancy 92 to the external space. Further, the auxiliary pumping cell 124 is capable of drawing oxygen from the external space into the second internal vacancy 92.

Further, an oxygen partial pressure detecting sensor cell 130 for controlling the auxiliary pump controls the oxygen partial pressure within the atmosphere inside the second internal vacancy 92. Hereinafter, the oxygen partial pressure detecting sensor cell 130 for controlling the auxiliary pump will be referred to as an auxiliary pump sensor cell 130. The auxiliary pump sensor cell 130 is an electrochemical sensor cell. The auxiliary pump sensor cell 130 includes the auxiliary pump electrode 126, the reference electrode 102, the second solid electrolyte layer 70, the spacer layer 68, and the first solid electrolyte layer 66.

Moreover, the auxiliary pump sensor cell 130 detects an electromotive force V1. A variable power source 132 is voltage-controlled based on the detected electromotive force V1. The auxiliary pumping cell 124 carries out pumping using the variable power source 132. Consequently, the oxygen partial pressure within the atmosphere inside the second internal vacancy 92 is controlled so as to become a low partial pressure that does not substantially influence the measurement of NOx.

Further, a pump current Ip1 is used to control the electromotive force V0 of the main pump sensor cell 120. More specifically, the electromotive force V0 is controlled by inputting the pump current Ip1 as a control signal to the main pump sensor cell 120. Consequently, a gradient of the oxygen partial pressure within the gas to be measured, which is introduced from the third diffusion rate control member 90 into the interior of the second internal vacancy 92, is controlled so as to always remain constant. When the gas sensor 10 is used as an NOx sensor, by the actions of the main pumping cell 110 and the auxiliary pumping cell 124, the oxygen concentration in the interior of the second internal vacancy 92 is maintained at a constant value on the order of 0.001 [ppm].

The fourth diffusion rate control member 94 imparts a predetermined diffusion resistance to the gas to be measured, the oxygen concentration (oxygen partial pressure) of which is controlled by operation of the auxiliary pumping cell 124 in the interior of the second internal vacancy 92. Further, the fourth diffusion rate control member 94 guides the gas to be measured to which the predetermined diffusion resistance is imparted into the third internal vacancy 96. The fourth diffusion rate control member 94 limits the amount of NOx that flows into the third internal vacancy 96.

The gas to be measured, the oxygen concentration (oxygen partial pressure) of which has been adjusted beforehand in the interior of the second internal vacancy 92, is introduced through the fourth diffusion rate control member 94 into the third internal vacancy 96. More specifically, the third internal vacancy 96 serves as a space in order to perform a process related to measurement of a nitrogen oxide (NOx) concentration within the gas to be measured that has been introduced. In the interior of the third internal vacancy 96, measurement of the NOx concentration is primarily performed by operation of a measurement pumping cell 140.

The measurement pumping cell 140 performs measurement of the NOx concentration within the gas to be measured in the interior of the third internal vacancy 96. The measurement pumping cell 140 is an electrochemical pumping cell. The measurement pumping cell 140 includes a measurement electrode 134, the outer side pump electrode 114, the second solid electrolyte layer 70, the spacer layer 68, and the first solid electrolyte layer 66. The measurement electrode 134 is formed directly on the upper surface of the first solid electrolyte layer 66 in facing relation to the third internal vacancy 96. The measurement electrode 134, for example, is a porous cermet electrode. The measurement electrode 134 also functions as an NOx reduction catalyst for reducing NOx existing within the atmosphere inside the third internal vacancy 96.

The measurement pumping cell 140 pumps out oxygen that is generated by the decomposition of the nitrogen oxide within the atmosphere around the periphery of the measurement electrode 134, and detects the generated amount as a pump current Ip2.

Further, an oxygen partial pressure detecting sensor cell 142 for controlling the measurement pump detects the oxygen partial pressure around the periphery of the measurement electrode 134. Hereinafter, the oxygen partial pressure detecting sensor cell 142 for controlling the measurement pump will be referred to as a measurement pump sensor cell 142. The measurement pump sensor cell 142 is an electrochemical sensor cell. The measurement pump sensor cell 142 includes the first solid electrolyte layer 66, the measurement electrode 134, and the reference electrode 102. A variable power source 144 is controlled based on the electromotive force V2 detected by the measurement pump sensor cell 142.

The gas to be measured which is guided into the interior of the second internal vacancy 92 reaches the measurement electrode 134 of the third internal vacancy 96 through the fourth diffusion rate control member 94, under a condition in which the oxygen partial pressure is controlled. The nitrogen oxide within the gas to be measured around the periphery of the measurement electrode 134 is reduced to thereby generate oxygen (2NO→N₂+O₂). The generated oxygen is subjected to pumping by the measurement pumping cell 140. Further, the voltage Vp2 of the variable power source 144 is controlled in a manner so that the electromotive force V2 detected by the measurement pump sensor cell 142 becomes constant. The amount of oxygen generated around the periphery of the measurement electrode 134 is proportional to the concentration of the nitrogen oxide within the gas to be measured. Therefore, the concentration of the nitrogen oxide within the gas to be measured can be calculated using the pump current Ip2 of the measurement pumping cell 140.

Further, a sensor cell 146 is an electrochemical sensor cell. The sensor cell 146 includes the second solid electrolyte layer 70, the spacer layer 68, the first solid electrolyte layer 66, the third substrate layer 64, the outer side pump electrode 114, and the reference electrode 102. In accordance with the electromotive force Vref obtained by the sensor cell 146, it is possible to detect the oxygen partial pressure within the gas to be measured existing externally of the gas sensor 10.

Furthermore, a reference gas adjusting pumping cell 150 is an electrochemical pumping cell. The reference gas adjusting pumping cell 150 includes the second solid electrolyte layer 70, the spacer layer 68, the first solid electrolyte layer 66, the third substrate layer 64, the outer side pump electrode 114, and the reference electrode 102. In the reference gas adjusting pumping cell 150, a variable power source 152 is connected between the outer side pump electrode 114 and the reference electrode 102. By applying a voltage Vp3, the variable power source 152 causes a control current Ip3 to flow between the outer side pump electrode 114 and the reference electrode 102. Consequently, the reference gas adjusting pumping cell 150 carries out pumping. As a result, the reference gas adjusting pumping cell 150 draws in oxygen from the space (the sensor element chamber 30 shown in FIG. 1) around the periphery of the outer side pump electrode 114 into the space (the atmospheric gas introduction layer 100) around the periphery of the reference electrode 102. The voltage Vp3 of the variable power source 152 is determined beforehand as a DC voltage, in a manner so that the control current Ip3 becomes a predetermined value (a DC current of a constant value).

In the gas sensor 10, by operating the main pumping cell 110 and the auxiliary pumping cell 124, the gas to be measured, in which the oxygen partial pressure thereof is always maintained at a constant low value, is supplied to the measurement pumping cell 140. The low value in which the oxygen partial pressure is always constant indicates a value that does not substantially influence the measurement of NOx. Accordingly, on the basis of the pump current Ip2 described above, the NOx concentration within the gas to be measured can be known. Moreover, as described previously, the pump current Ip2 flows due to pumping out the oxygen generated by the reduction of NOx from the measurement pumping cell 140, substantially in proportion to the concentration of NOx in the gas to be measured.

Furthermore, the sensor element 12 is equipped with a heater unit 160 which plays a role in adjusting the temperature for heating, and to maintain the sensor element 12 in a heated condition. In accordance with this feature, the oxygen ion conductivity of the solid electrolyte is increased. The heater unit 160 includes a heater connector electrode 162, a ceramic heater 164, a through hole 166, a heater insulating layer 168, a pressure dissipation hole 170, and lead wires 172.

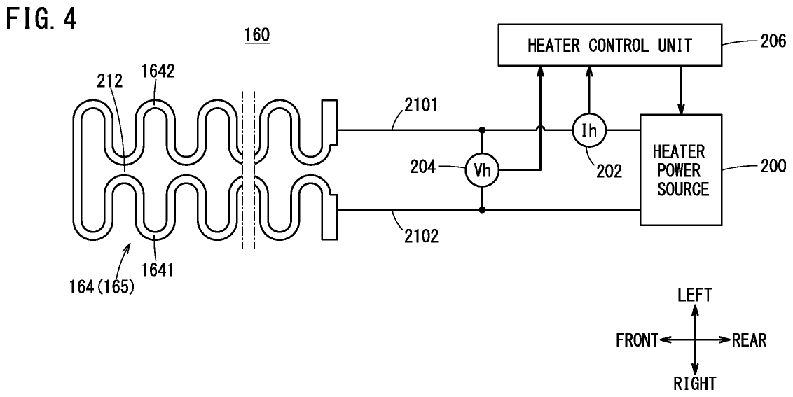

Further, as shown in FIG. 4, the sensor element 12 includes a heater power source 200, a heater current acquisition unit 202, a heater voltage acquisition unit 204, and a heater control unit 206.

The heater power source 200 is connected to the ceramic heater 164 via current supplying leads 2101 and 2102. The heater power source 200 supplies electrical power to the ceramic heater 164 to thereby cause the ceramic heater 164 to generate heat. A heater current Ih flows through the ceramic heater 164 due to the heater power source 200.

The heater current acquisition unit 202 is a current detection circuit that acquires the heater current Ih. The heater current acquisition unit 202 is connected between the ceramic heater 164 and the heater power source 200. The heater current acquisition unit 202 outputs the acquired heater current Ih to the heater control unit 206.

The heater voltage acquisition unit 204 is a voltage detection circuit that acquires a heater voltage Vh, which is a voltage (potential difference) across both ends of the ceramic heater 164. The heater voltage acquisition unit 204 is connected between the current supplying leads 2101 and 2102. The heater current acquisition unit 204 outputs the acquired heater voltage Vh to the heater control unit 206.

Further, as shown in FIG. 2, the ceramic heater 164 is embedded over the entire area from the first internal vacancy 88 to the third internal vacancy 96. The ceramic heater 164 is capable of adjusting the entire sensor element 12 to a temperature at which the solid electrolyte becomes activated (for example, 800[° C.] to 900 [° C.]).

The heater insulating layer 168 is formed on the upper and lower surfaces of the ceramic heater 164 by an insulator such as alumina. The heater insulating layer 168 is an insulating layer having porous alumina. The heater insulating layer 168 is formed with the aim of obtaining electrical insulation between the second substrate layer 62 and the ceramic heater 164, as well as electrical insulation between the third substrate layer 64 and the ceramic heater 164.

The pressure dissipation hole 170 is provided so as to penetrate through the third substrate layer 64 and communicate with the reference gas introduction space 98. The pressure dissipation hole 170 is formed with the aim of alleviating an increase in internal pressure accompanying a rise in the temperature inside the heater insulating layer 168.

Moreover, the variable power sources 122, 144, 132, and 152 and the like shown in FIG. 2 are actually connected to each of the electrodes via non-illustrated lead wires formed in the interior of the sensor element 12, or via the connector 22 and the lead wires 50.

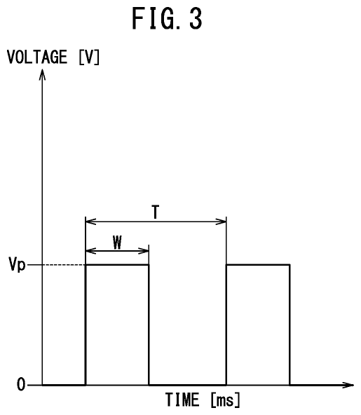

The ceramic heater 164 provided in the gas sensor 10 according to the present embodiment is controlled to be at a temperature of greater than or equal to 700[° C.] and less than 950[° C.] by applying a pulse voltage. In accordance therewith, the output value and output accuracy of the sensor element 12 are maintained. As shown in FIG. 3, the voltage applied to the ceramic heater 164 is defined by a ratio (duty ratio) of the pulse voltage Vp, a period T, and a pulse width W.

The ceramic heater 164 includes a first pattern 1641 and a second pattern 1642. In the first pattern 1641 and the second pattern 1642, for example, as shown in FIG. 4, a plurality of meandering patterns are continuously formed, respectively. The first pattern 1641 and the second pattern 1642 are formed in parallel with each other. A distal end of the first pattern 1641 and a distal end of the second pattern 1642 are joined to each other. The first pattern 1641 and the second pattern 1642 make up a heat generating portion 165 of the ceramic heater 164. The term “joined” includes a state of being electrically connected to each other.

The ceramic heater 164 has portions in which the first pattern 1641 (conductor) and the second pattern 1642 (conductor) are close to each other, and portions in which the first pattern 1641 and the second pattern 1642 are far away from each other. Further, a non-metal medium 212 is interposed between the first pattern 1641 and the second pattern 1642. The non-metal medium 212 prevents short circuiting from occurring between the first pattern 1641 and the second pattern 1642. Moreover, a portion of the heater insulating layer 168 may serve as the non-metal medium 212.

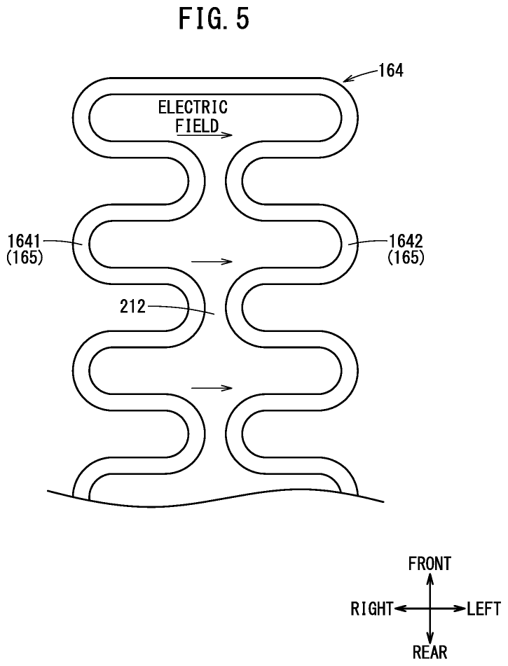

As shown in FIG. 5, when a voltage difference exists between the first pattern 1641 (conductor) and the second pattern 1642 (conductor), an electric field is generated between the first pattern 1641 and the second pattern 1642. For example, if the first pattern 1641 has a high potential and the second pattern 1642 has a low potential, then as shown by the arrows in FIG. 5, an electric field is generated from the first pattern 1641 toward the second pattern 1642.

Under the influence of such an electric field, for example, ion migration by alkali metal ions or alkaline earth metal ions takes place. More specifically, ion migration by calcium ions Ca2+ or sodium ions Na+ takes place. Due to the generation of such ion migration, cases may occur in which the ceramic heater 164 suffers from deterioration, and thinning or a disconnection may occur.

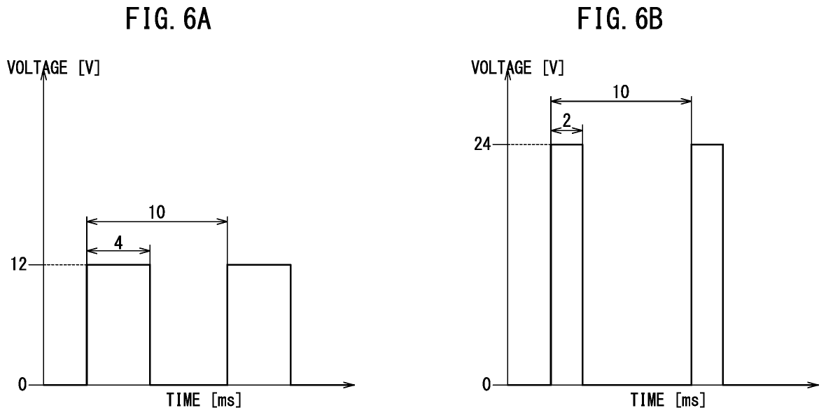

When a case is assumed in which the energizing current waveform to the heat generating portion 165 is a pulse waveform, the following consideration is understood. More specifically, as shown in FIGS. 3, 6A, and 6B, even if the effective power value (pulse voltage Vp X pulse width W) of each of the respective pulse waveforms is the same, the larger the drive voltage parameter X taken in consideration of the period T becomes, the more the deterioration progresses. Thus, according to the present embodiment, the energizing current waveform to the heat generating portion 165 (see FIG. 4) is made into a pulse waveform, and the drive voltage parameter X is controlled to be less than or equal to 600 [V·ms]. Moreover, the drive voltage parameter X indicates the product of the pulse voltage Vp [V] and the period T (unit period) [ms] of the pulse waveform.

As examples of the pulse waveform, for example, there may be cited the pulse waveform shown in FIG. 6A or the pulse waveform shown in FIG. 6B. The pulse waveform shown in FIG. 6A is a waveform having a pulse voltage of 12 [V], a pulse width of 4 [ms], and a period of 10 [ms]. The pulse waveform shown in FIG. 6B is a waveform having a pulse voltage of 24 [V], a pulse width of 2 [ms], and a period of 10 [ms].

In the examples shown in FIGS. 6A and 6B, the products (areas) of the pulse voltages and the pulse widths in one unit period are the same. Stated otherwise, in both of the examples shown in FIGS. 6A and 6B, a value of 48 [V·ms] is continuously energized every cycle. The drive voltage parameter X is 120 [V·ms] in the example shown in FIG. 6A, and is 240 [V·ms] in the example shown in FIG. 6B. Therefore, the effective power value is the same value for both pulse energization and continuous energization. However, the drive voltage parameter X is larger in the example of FIG. 6B than in the example of FIG. 6A. Accordingly, in the example shown in FIG. 6B, deterioration of the ceramic heater 164 is more likely to occur.

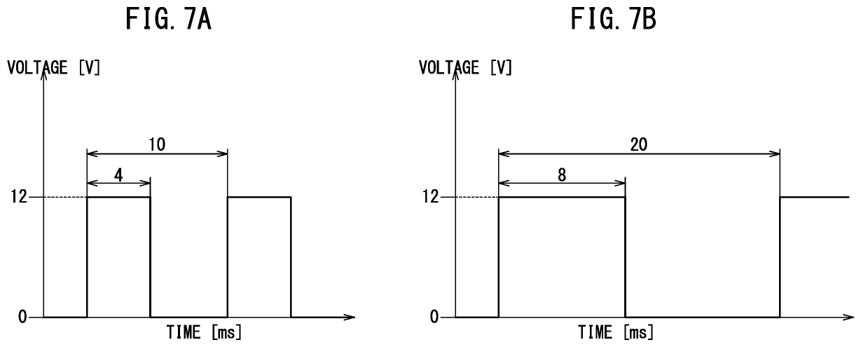

As other examples of the pulse waveform, for example, there may be cited the pulse waveform shown in FIG. 7A and the pulse waveform shown in FIG. 7B. The pulse waveform shown in FIG. 7A is a waveform having a pulse voltage of 12 [V], a pulse width of 4 [ms], and a period of 10 [ms]. The pulse waveform shown in FIG. 7B is a waveform having a pulse voltage of 12 [V], a pulse width of 8 [ms], and a period of 20 [ms]. In the examples shown in FIGS. 7A and 7B, the products (areas) of the pulse voltages and the pulse widths in one unit period (20 [ms]) are the same. Stated otherwise, in the example of FIG. 7A, a value of 48 [V·ms] is continuously energized in a period (10 [ms]). In the example of FIG. 7B, a value of 96 [V·ms] is continuously energized in a period (20 [ms]). The drive voltage parameter X is 120 [V·ms] in the example shown in FIG. 7A, and is 240 [V·ms] in the example shown in FIG. 7B. The drive voltage parameter X is larger in the example of FIG. 7B than in the example of FIG. 7A. Accordingly, in the example shown in FIG. 7B, deterioration of the ceramic heater 164 is more likely to occur.

If the application time period over which the voltage is applied to the ceramic heater 164 is short, and the applied voltage is low, movement of ions is less likely to occur. Further, even if the duty ratio of the pulse waveform is constant, as the period becomes longer, the longer the time period that the voltage is applied per each one pulse. This makes it easy for movement of ions to occur. It should be noted that the aforementioned numerical values, such as the pulse voltage and the pulse width and the like, are merely provided by way of example.

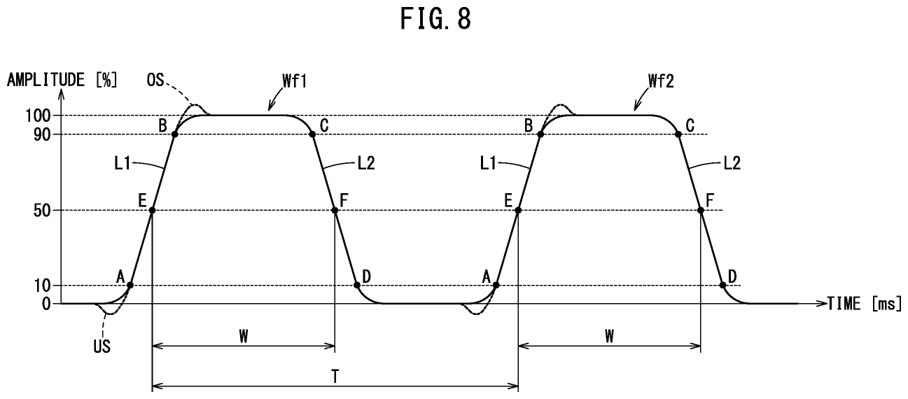

In FIGS. 3 and 6A to 7B, although a rectangular waveform is shown as the pulse waveform, the pulse waveform is not limited to such a waveform. For example, as shown in FIG. 8, as the pulse waveform, a first inclined portion L1 that rises together with the passage of time may exist at a leading part of the pulse waveform. Further, a second inclined portion L2 that falls together with the passage of time may exist at a rear part of the pulse waveform. Furthermore, a corner portion and the rising portion of the pulse waveform may be curved. Moreover, as shown by the dashed lines, an undershoot US may exist at a starting portion of the rise, and an overshoot OS may exist at a subsequent portion of the rise.

In the pulse waveform shown in FIG. 8, the pulse width W refers to a time period from a time point E, which is at 50 [%] of the peak value of a first inclined portion L1, to a time point F, which is at 50 [%] of the peak value of a second inclined portion L2. The above-described peak value excludes the overshoot OS. The period T, for example, refers to a time period from the time point E of the first inclined portion L1 in the leading pulse waveform Wf1 to the time point E of the first inclined portion L1 in the subsequent pulse waveform Wf2.

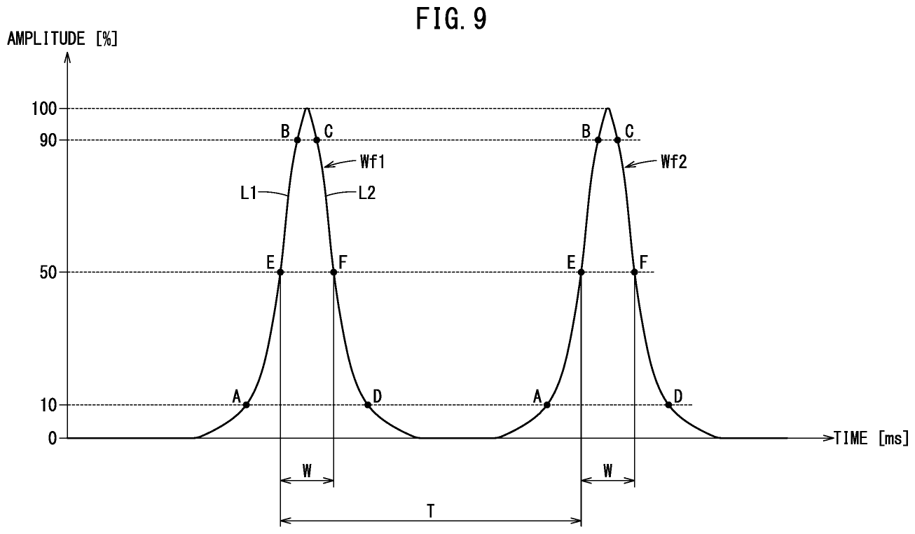

In addition, as shown in FIG. 9, the pulse waveform may be a triangular pulse waveform in which the first inclined portion L1 and the second inclined portion L2 are close to each other. The pulse width W is the same as in the pulse waveform Wf1 (Wf2) shown in FIG. 8 described above. More specifically, the pulse width W refers to a time period from a time point E, which is at 50 [%] of the peak value of the first inclined portion L1, to a time point F, which is at 50 [%] of the peak value of the second inclined portion L2. The period T, for example, refers to a time period from the time point E of the first inclined portion L1 in the leading pulse waveform Wf1 to the time point E of the first inclined portion L1 in the subsequent pulse waveform Wf2.

In FIG. 3 and FIGS. 6A to 9 and the like described above, as for the pulse waveform, an interval in which the pulse voltage is not applied is set to 0 [V]. The pulse waveform may include an offset.

As examples of the pulse waveform, apart from the examples discussed above, there may be cited a half-wave rectified wave, a triangular wave, a sawtooth wave, a trapezoidal wave, a sinusoidal pulse wave, and the like. Also in these waveforms, the pulse width, the period, and the like can be defined in conformity with the examples shown in FIGS. 8 and 9 and the like.

In this instance, the following test was conducted in relation to Examples 1 to 9 and Comparative Example. The test was conducted in an environment in which the environmental temperature was 25[° C.] and the wind speed was approximately 15 [m/s]. In this test, the drive voltage parameter X [V·ms], which is the product of the pulse voltage applied to the ceramic heater 164 and the period, was made to change, and the rate of increase in the heater resistance value after 2000 hours was measured.

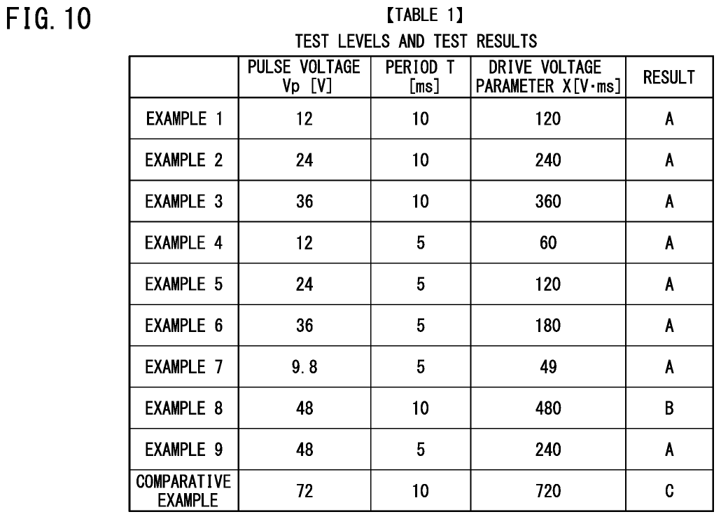

Table 1 of FIG. 10 shows test levels and test results of the pulse voltage Vp [V], the period T [ms], and the drive voltage parameter X [V·ms] of Examples 1 to 9 and Comparative Example.

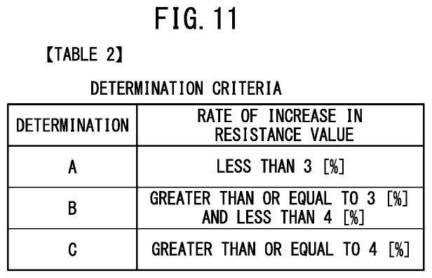

The determination criteria are as follows. More specifically, when the ceramic heater 164 undergoes thinning and the resistance value rises, the temperature and the temperature distribution of a vacant chamber inside the gas sensor 10 change. Consequently, an influence is imparted to the output value and the signal accuracy of the gas sensor 10. Therefore, it is preferable for the rate of increase in the heater resistance value to be less than 4 [%]. In order to maintain even greater output accuracy, the rate of increase in the heater resistance value is preferably suppressed to less than 3 [%]. Thus, as shown in Table 2 of FIG. 11, as the determination criteria, the aforementioned rate of increase in the heater resistance value was designated as A when less than 3 [%], was designated as B when greater than or equal to 3 [%] and less than 4 [%], and was designated as C when greater than or equal to 4 [%].

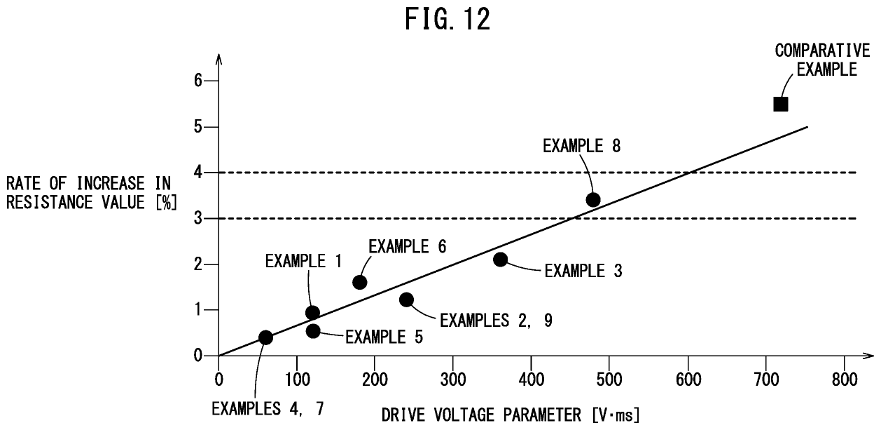

FIG. 12 is a graph showing a change in the rate of increase in the heater resistance value with respect to the drive voltage parameter. From the graph of FIG. 12, it can be seen that the relationship between the drive voltage parameter and the rate of increase in the heater resistance value is substantially proportional.

The following items are derived from the graph of FIG. 12. (1) The energizing current waveform to the heat generating portion 165 is a pulse waveform. (2) It is preferable for the product of the pulse voltage Vp [V] and the period T [ms] of the pulse waveform to be less than or equal to 600 [V·ms]. (3) It is further preferable for the aforementioned product to be less than 450 [V·ms]. By being set in this manner, a rate of increase in the heater resistance value after being driven over a prolonged time period can be suppressed.

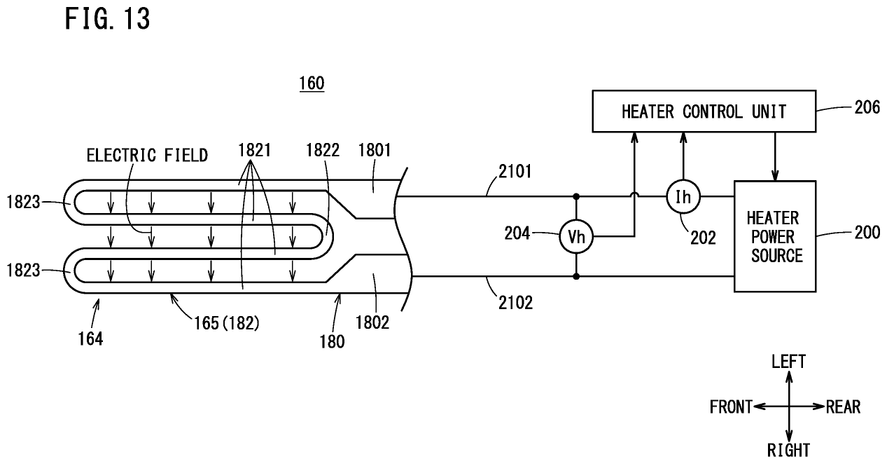

A first modified example of the present embodiment will be described with reference to FIG. 13. In the first modified example, the pattern of the conductors that make up the ceramic heater 164 differs from the patterns shown in FIGS. 4 and 5. More specifically, the ceramic heater 164 includes lead portions 180 and the heat generating portion 165.

The lead portions 180 are made up from a first lead portion 1801 connected to the current supplying lead 2101, and a second lead portion 1802 connected to the current supplying lead 2102. The heat generating portion 165 is a conductor pattern 182 in which one end is joined to the first lead portion 1801, and another end is joined to the second lead portion 1802. The conductor pattern 182 is a conductor pattern that meanders from the first lead portion 1801 toward the second lead portion 1802.

More specifically, at intervals in the left-right direction (widthwise direction) of the sensor element 12, the conductor pattern 182 includes four straight portions 1821 that extend in the front-rear direction (lengthwise direction) of the sensor element 12. Among the four straight portions 1821, a rear end part of a left end straight portion 1821 is joined to the first lead portion 1801. Further, a rear end part of a right end straight portion 1821 is joined to the second lead portion 1802.

Among the four straight portions 1821, rear end parts of two of the straight portions 1821 which lie adjacent to each other centrally in the left-right direction are joined to each other via a first connecting portion 1822. The first connecting portion 1822 has a U-shaped curved pattern shape, and is in close proximity to the lead portions 180 (the first lead portion 1801 and the second lead portion 1802).

Among the four straight portions 1821, front end parts of two of the straight portions 1821 which lie adjacent to each other on the left side are joined to each other via one second connecting portion 1823. Further, front end parts of two of the straight portions 1821 which lie adjacent to each other on the right side are joined to each other via another second connecting portion 1823. Further, each of the second connecting portions 1823 has a U-shaped curved pattern shape, and is separated away from the lead portions 180 (the first lead portion 1801 and the second lead portion 1802).

In this instance, in the case that the heater power source 200 carries out supply of current to the heat generating portion 165 (the conductor pattern 182) via the current supplying leads 2101 and 2102 and the lead portions 180, when a voltage difference exists between the plurality of straight portions 1821, an electric field is generated between the plurality of straight portions 1821. For example, among two adjacent ones of the straight portions 1821, if one of the straight portions 1821 has a high potential and the other of the straight portions 1821 has a low potential, then as shown by the arrows in FIG. 13, an electric field is generated from the one of the straight portions 1821 toward the other of the straight portions 1821. Further, by supplying current to the conductor pattern 182, the conductor pattern 182 becomes high in temperature. In this manner, together with the potential difference (electric field) being generated, since it is used at a high temperature, deterioration of the ceramic heater 164 is likely to occur. In particular, deterioration is likely to occur between the two straight portions 1821.

Thus, even in the first modified example, in the case that the heat generating portion 165 is heated to be greater than or equal to 700[° C.] and less than 950[° C.], the pulse waveforms shown in FIGS. 6A to 9 are applied to the heat generating portion 165. Consequently, deterioration due to driving of the heater can be suppressed, and together therewith, a rate of increase in the heater resistance value after being driven over a prolonged time period can be suppressed.

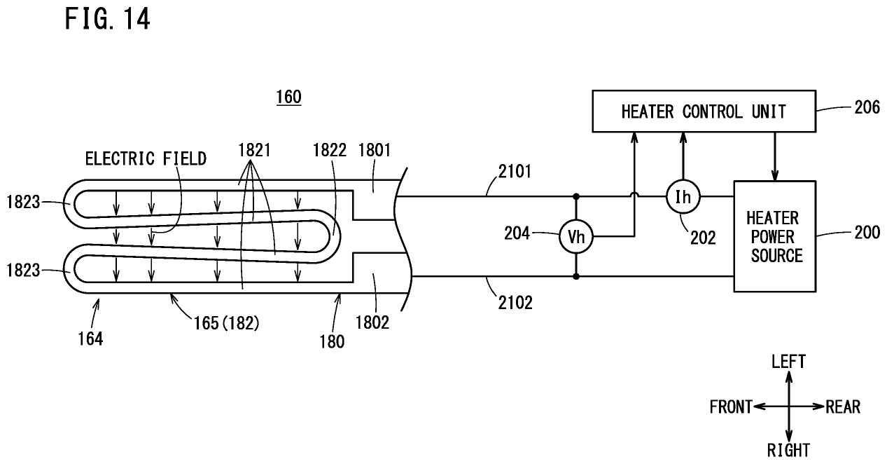

The second modified example shown in FIG. 14 differs from the first modified example of FIG. 13, in that two straight portions 1821 which lie adjacent to each other centrally in the left-right direction come in closer proximity to each other toward the front direction. Accordingly, the distance between the front ends of the two straight portions 1821 which lie adjacent to each other centrally in the left-right direction is shorter than the distance between the rear ends of the two straight portions 1821. Therefore, in the case that current is supplied to the heat generating portion 165, the electric field generated between the front ends of the two straight portions 1821 lying adjacent to each other centrally in the left-right direction is greater than the electric field generated at the rear ends of the two straight portions 1821. As a result, deterioration becomes likely to occur between the two straight portions 1821. Accordingly, even in the second modified example, in the case that the heat generating portion 165 is heated to be greater than or equal to 700[° C.] and less than 950[° C.], by applying the pulse waveforms shown in FIGS. 6A to 9 to the heat generating portion 165, the same effects as those of the first modified example are obtained.

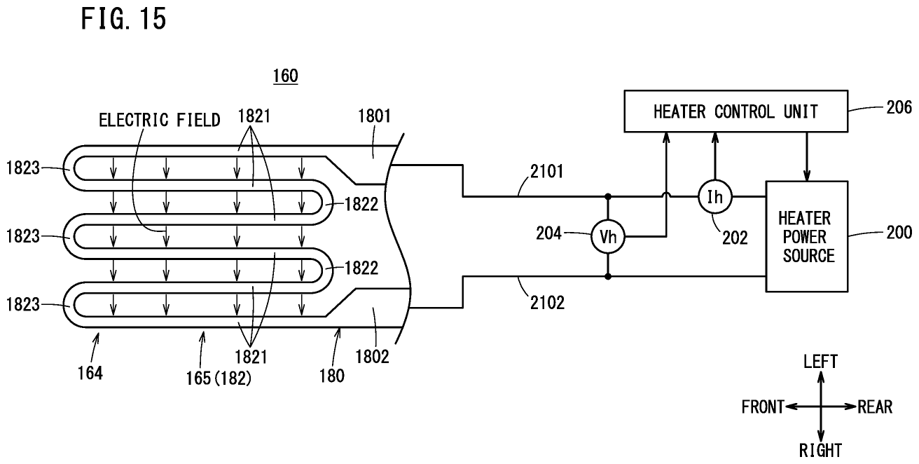

The third modified example shown in FIG. 15 differs from the first modified example of FIG. 13 in that six of the straight portions 1821 are provided. Therefore, a rear end part of the second straight portion 1821 from the left and a rear end part of the third straight portion 1821 from the left are connected to each other via one of the first connecting portions 1822. Further, a rear end part of the second straight portion 1821 from the right and a rear end part of the third straight portion 1821 from the right are connected to each other via another one of the first connecting portions 1822.

Further, a front end part of a left end straight portion 1821 and a front end part of the second straight portion 1821 from the left are connected to each other via a left side second connecting portion 1823. Furthermore, front end parts of two central straight portions 1821 in the left-right direction are connected to each other via a central second connecting portion 1823. Further still, a front end part of a right end straight portion 1821 and a front end part of the second straight portion 1821 from the right are connected to each other via a right side second connecting portion 1823.

Even in the third modified example, when current is supplied to the heat generating portion 165, an electric field is generated between two adjacent ones of the straight portions 1821. As a result, deterioration is likely to occur between the two straight portions 1821. Accordingly, even in the third modified example, in the case that the heat generating portion 165 is heated to be greater than or equal to 700[° C.] and less than 950[° C.], by applying the pulse waveforms shown in FIGS. 6A to 9 to the heat generating portion 165, the same effects as those of the first modified example are obtained.

It should be noted that FIGS. 13 to 15 illustrate the first to third modified examples in an exemplary manner, and the number of the straight portions 1821 may be four or more.

Further, in the above-described embodiment, the sensor element 12 detects the NOx concentration within the gas to be measured. In the above described embodiment, it is sufficient insofar as the concentration of a specified gas within the gas to be measured can be detected. For example, the oxygen concentration within the gas to be measured may be detected.

The above-described embodiment can be summarized in the manner described below.

[1] The ceramic heater (164), which is provided in the electronic component, is configured so that by supplying electrical current thereto, the heat generating portion (165) thereof is heated to a temperature of greater than or equal to 700[° C.] and less than 950[° C.], wherein the energizing current waveform of the electrical current to the heat generating portion (165) is a pulse waveform, and a product of the pulse voltage [V] and the period [ms] of the pulse waveform is less than or equal to 600 [V·ms]. In accordance with this feature, by being applied to the electronic component such as the gas sensor (10) or the like, deterioration due to driving of the heater can be suppressed. In addition, the rate of increase in the heater resistance value can be suppressed to less than 4 [%].

[2] The product of the pulse voltage [V] and the period [ms] of the pulse waveform is less than 450 [V·ms]. In accordance with this feature, by being applied to the electronic component such as the gas sensor (10) or the like, deterioration due to driving of the heater can be suppressed. In addition, the rate of increase in the heater resistance value can be suppressed to less than 3 [%].

[3] The heat generating portion (165) has a shape in which a portion in which the heater patterns (1641 and 1642) are far away from each other, and a portion in which the heater patterns are close to each other are repeated multiple times from the pair of connection terminals, and the heater patterns are joined at a distal end part.

In this case, if a voltage difference exists between each of the heater patterns (1641 and 1642), so-called ion migration is likely to occur between the respective heater patterns (1641 and 1642). Thus, by being applied to the configurations of items [1] and [2], deterioration due to driving of the heater can be suppressed. In addition, the rate of increase in the heater resistance value can be suppressed to less than 4 [%].

[4] The heat generating portion (165) is heated by supplying current thereto through the lead portions (180), and the heat generating portion (165) includes at least four of the straight portions (1821) arranged at intervals in a widthwise direction of the electronic component, and which extend in a lengthwise direction of the electronic component, at least one of the first connecting portions (1822) that connects end parts in proximity to the lead portions (180) at two of the straight portions (1821) that are adjacent to each other in the widthwise direction, and a plurality of the second connecting portions (1823) that connect end parts remote from the lead portions (180) at two of the straight portions (1821) that are adjacent to each other in the widthwise direction.

In this case as well, if a voltage difference exists between the two adjacent ones of the straight portions (1821), so-called ion migration is likely to occur between the two straight portions (1821). Thus, by being applied to the configurations of items [1] and [2], deterioration due to driving of the heater can be suppressed. In addition, the rate of increase in the heater resistance value can be suppressed to less than 4 [%].

[5] In the ceramic heater (164), the electronic component is the gas sensor (10). More specifically, by being applied to the gas sensor (10), deterioration due to driving of the heater can be suppressed. In addition, the rate of increase in the heater resistance value can be suppressed to less than 4 [%].

[6] The method of driving the ceramic heater (164) provided in the electronic component, in which by supplying electrical current thereto, the heat generating portion (165) is heated to a temperature of greater than or equal to 700[° C.] and less than 950[° C.], wherein the energizing current waveform of the electrical current to the heat generating portion (165) is a pulse waveform, and the product of a pulse voltage [V] and the period [ms] of the pulse waveform is less than or equal to 600 [V·ms]. In accordance with this feature, by being applied to the electronic component such as the gas sensor (10) or the like, deterioration due to driving of the heater can be suppressed. In addition, the rate of increase in the heater resistance value can be suppressed to less than 4 [%].

[7] In the method of driving the ceramic heater (164), the electronic component is the gas sensor (10). More specifically, by being applied to the gas sensor (10), deterioration due to driving of the heater can be suppressed. In addition, the rate of increase in the heater resistance value can be suppressed to less than 4 [%].

[8] The gas sensor (10) having the ceramic heater (164), the ceramic heater (164) being configured so that by supplying electrical current thereto, the heat generating portion (165) thereof is heated to a temperature of greater than or equal to 700[° C.] and less than 950[° C.], wherein the energizing current waveform of the electrical current to the heat generating portion (165) is a pulse waveform, and the product of a pulse voltage [V] and the period [ms] of the pulse waveform is less than or equal to 600 [V·ms]. In accordance with these features, in the gas sensor (10), deterioration due to driving of the heater can be suppressed. In addition, the rate of increase in the heater resistance value can be suppressed to less than 4 [%].

The present invention is not limited to the embodiments described above, but various configurations could be adopted therein without deviating from the essence and gist of the present invention.

What is claimed is:

1. A ceramic heater provided in an electronic component, the ceramic heater being configured so that by supplying electrical current thereto, a heat generating portion thereof is heated to a temperature of greater than or equal to 700[° C.] and less than 950[° C.];
wherein an energizing current waveform of the electrical current to the heat generating portion is a pulse waveform, and a product of a pulse voltage [V] and a period [ms] of the pulse waveform is less than or equal to 600 [V·ms].

2. The ceramic heater according to claim 1, wherein the product of the pulse voltage [V] and the period [ms] of the pulse waveform is less than 450 [V·ms].

3. The ceramic heater according to claim 1, wherein:
the heat generating portion has a shape in which a portion in which heater patterns are far away from each other, and a portion in which the heater patterns are close to each other are repeated multiple times from a pair of connection terminals, and the heater patterns are joined at distal end parts thereof.

4. The ceramic heater according to claim 1, wherein:
the heat generating portion is heated by supplying current thereto through lead portions; and
the heat generating portion comprises:
at least four straight portions arranged at intervals in a widthwise direction of the electronic component, and configured to extend in a lengthwise direction of the electronic component;
at least one first connecting portion which is configured to connect end parts in proximity to the lead portion at two of the straight portions that are adjacent to each other in the widthwise direction; and
a plurality of second connecting portions which are configured to connect end parts remote from the lead portion at two of the straight portions that are adjacent to each other in the widthwise direction.

5. The ceramic heater according to claim 1, wherein the electronic component is a gas sensor.

6. A method of driving a ceramic heater provided in an electronic component, the ceramic heater being configured so that by supplying electrical current thereto, a heat generating portion thereof is heated to a temperature of greater than or equal to 700[° C.] and less than 950[° C.];
wherein an energizing current waveform of the electrical current to the heat generating portion is a pulse waveform; and
a product of a pulse voltage [V] and a period [ms] of the pulse waveform is less than or equal to 600 [V·ms].

7. The method of driving a ceramic heater according to claim 6, wherein the electronic component is a gas sensor.

8. A gas sensor having a ceramic heater, the ceramic heater being configured so that by supplying electrical current thereto, a heat generating portion thereof is heated to a temperature of greater than or equal to 700[° C.] and less than 950[° C.], wherein an energizing current waveform of the electrical current to the heat generating portion is a pulse waveform, and a product of a pulse voltage [V] and a period [ms] of the pulse waveform is less than or equal to 600 [V·ms].
